(19) United States
(12) Patent Application Publication
(10) Pub. No.: US 2005/0236815 A1
(43) Pub. Date: Oct. 27, 2005

(54) Method of assembling an airbag, and an airbag

(76) Inventors: Altay Kismir, Ontario (CA); David Stow, Gothenburg (SE)

Correspondence Address: BRINKS HOFER GILSON & LIONE, P.O. BOX 10395, CHICAGO, IL, 60610, US

(21) Appl. No.: 10/508,450

(22) PCT Filed: Feb. 24, 2003
(86) PCT No.: PCT/SE03/00295

§ 371 Date: Jun. 17, 2005

(30) Foreign Application Priority Data
Mar. 25, 2002 (GB) 0207033.2

(51) Int. Cl. B60R 21/16

(52) U.S. Cl. 280/728.1

(57) ABSTRACT

A method of assembling an air-bag comprises the steps of taking a gas-flow duct which is to be located within a gas-flow passage of an air-bag, and applying a hot-melt adhesive to one or more locations on the exterior of the gas-flow duct. The hot-melt adhesive is permitted to cool to a state in which it is substantially solid and exhibits little or no tack. The gas-flow duct may then be inserted into the gas-flow passage without affecting the adhesive in any way. Subsequently heat is applied so the hot-melt adhesive at least partially melts. The adhesive then adheres the gas-flow duct to that part of the air-bag defining the gas-flow passage. The hot-melt adhesive may cure over a period of time to form a substantially cross-linked adhesive.

### CROSS REFERENCE TO RELATED APPLICATION

This application claims priority to GB 0207033.2 filed Mar. 25, 2002 and PCT/SE03/00295 filed Feb. 24, 2003.

### BACKGROUND OF THE INVENTION

The present invention relates to a method of assembling an air-bag, and an air-bag assembled by the method. More particularly, the present invention relates to a method of assembling an air-bag where the air-bag defines a gas-flow passage communicating with a plurality of zones or regions within the air-bag which are to be inflated, and a gas-flow duct is inserted into the gas-flow passage.

It has been proposed to provide various air-bags in which the air-bag has a plurality of separate zones or regions which are to be inflated on deployment of the air-bag. For example, it has been proposed to provide air-bags in the form of so-called “inflatable curtains” which are initially stored in the roof of a motor vehicle above the door openings, and which, during an accident situation, may inflate to form a curtain which extends across the windows provided in the doors. Such an inflatable curtain typically has a design which is such that the curtain is divided up into a plurality of separate zones or regions which become inflated on deployment of the air-bag. Gas is, in many cases, supplied to the individual zones or regions by means of an internal gas-flow passage with a gas generator or inflator being located at one end of this gas-flow passage.

If an inflatable curtain is to provide adequate protection for a vehicle occupant during a side impact, the inflatable curtain must be fully inflated within a very short period of time, typically less than 20 ms. In order to achieve this rapid inflation, the gas generator must generate a substantial volume of gas within a very short period of time, and thus the flow of gas into the air-bag is very aggressive. This aggressive flow of gas may damage the air-bag.

It has been proposed that, in order to minimise the risk of damage to the air-bag, a tubular gas-flow duct should be provided located within the gas-flow passage and connected to the inflator or gas generator in such a way that the gas that is utilised to inflate the air-bag flows through the gas-flow duct and emerges through appropriately located apertures formed in the side-wall of the gas-flow duct to inflate the inflatable zones and regions of the inflatable curtain.

It has been proposed to use various types of gas-flow ducts including metallic gas-flow ducts, and fabric or textile gas-flow ducts. It is appropriate for the gas-flow duct to be maintained in a predetermined position relative to the rest of the air-bag, especially during folding of the air-bag and during transport of the folded air-bag, to ensure that apertures formed in the side-walls of the gas-flow duct are correctly positioned to facilitate the swift inflation of the inflatable curtain. Whilst it has been proposed (see, for example DE-A-19939618) to provide an air-bag where the gas-flow duct has parts thereof trapped within a seam forming part of the air-bag, so that the gas-flow duct is held in the appropriate position, this technique involves a complicated manufacturing step which cannot be effected if a one-piece weaving technique is utilised to fabricate the air-bag.

The present invention seeks to provide an improved method of assembling an air-bag.

### SUMMARY OF THE INVENTION

According to this invention there is provided a method of assembling an air-bag comprising the steps of taking a gas-flow duct which is to be located within a gas-flow passage defined by the air-bag and 1) applying a hot-melt adhesive to one or more locations on the exterior of the gas-flow duct, 2) permitting the hot-melt adhesive to cool to a state in which it is substantially solid and exhibits little or no tack, 3) inserting the gas-flow duct into the gas-flow passage and 4) subsequently applying heat so that the hot-melt adhesive at least partially melts to adhere the gas-flow duct to that part of the air-bag defining the gas-flow passage.

In one method of the invention the hot-melt adhesive is in the form of a film or tape of adhesive.

Preferably the film or tape is applied to the exterior of the gas-flow duct using an adhesive or glue.

Preferably the hot-melt adhesive is adapted to cure over a period of time to form a substantially cross-linked adhesive.

Conveniently the adhesive is adapted to cure in response to exposure to atmospheric moisture.

Preferably the adhesive is a reactive polyurethane hot-melt adhesive.

Advantageously the method includes a final step of exposing the combination of the air-bag and the gas-flow duct to a moist environment for a period of time.

In one embodiment the heat is applied by means of a heated plate or element brought into contact with the air-bag.

Alternatively the heat is applied by at least one hot-air jet.

In another method of the invention the heat is applied by electromagnetic radiation of High Frequency or Radio Frequency, or by means of light.

In a preferred embodiment of the invention the gas-flow duct is a fabric gas-flow duct, the gas-flow duct being inserted into the gas-flow passage whilst mounted on a mandrel.

In this embodiment of the invention it is possible for the heat to be applied by heating the mandrel.

In a further embodiment of the invention the gas-flow duct is a metallic or plastic gas-flow duct.

The invention also relates to an air-bag whenever assembled by a method as described above.

According to another aspect of this invention there is provided an air-bag, the air-bag defining a gas-flow passage, there being a gas-flow duct inserted into the passage, the gas-flow duct being adhered, at one or more locations, to the part of the air-bag defining the gas-flow passage by means of adhesive.

The adhesive may be a light initiated adhesive, or preferably a hot-melt adhesive.

Preferably the hot-melt adhesive is a hot-melt and curable adhesive.

Conveniently the adhesive is a reactive polyurethane hot-melt adhesive.

Advantageously the gas-flow passage communicates with a plurality of zones, regions, chambers or cells within the air-bag which are adapted to be inflated on deployment of the air-bag.

Conveniently the air-bag is an inflatable curtain.

In order that the invention may be more readily understood, and so that further features thereof may be appreciated, the invention will now be described, by way of example, with reference to the accompanying drawings in which:

### BRIEF DESCRIPTION OF THE DRAWINGS

FIG. 1 is a diagrammatic view of an air-bag in accordance with this invention,

FIG. 2 is a view of a gas-flow duct to be inserted into the air-bag,

FIG. 3 is a view of the gas-flow duct with adhesive,

FIG. 4 is a view corresponding to FIG. 3 showing the adhesive when partially cured,

FIG. 5 is a view illustrating the gas-flow duct being inserted into the air-bag, and

FIG. 6 is a view illustrating the air-bag with the gas-flow duct in position.

### DETAILED DESCRIPTION OF THE INVENTION

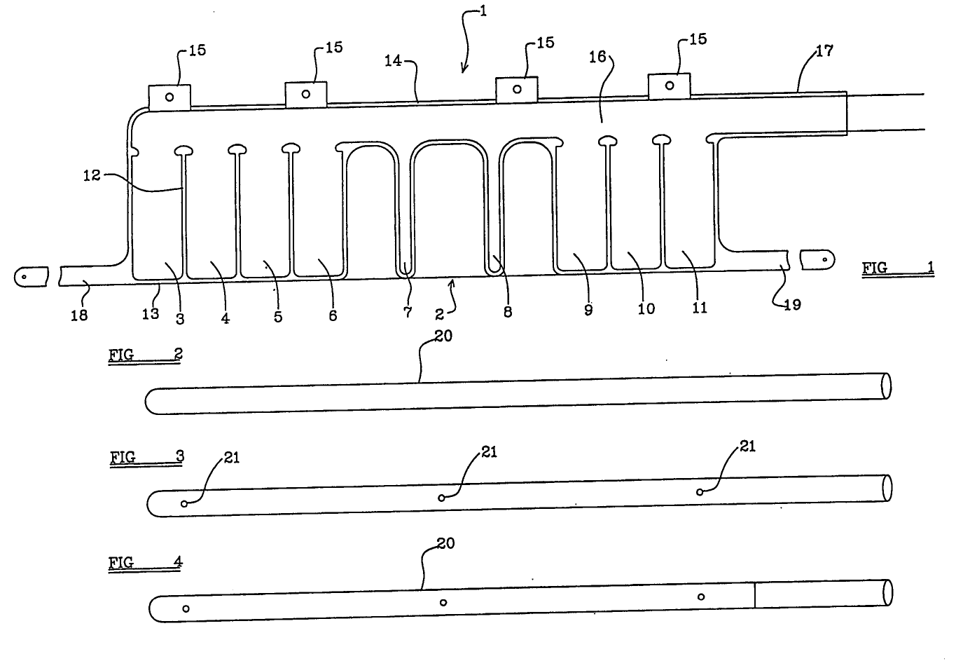

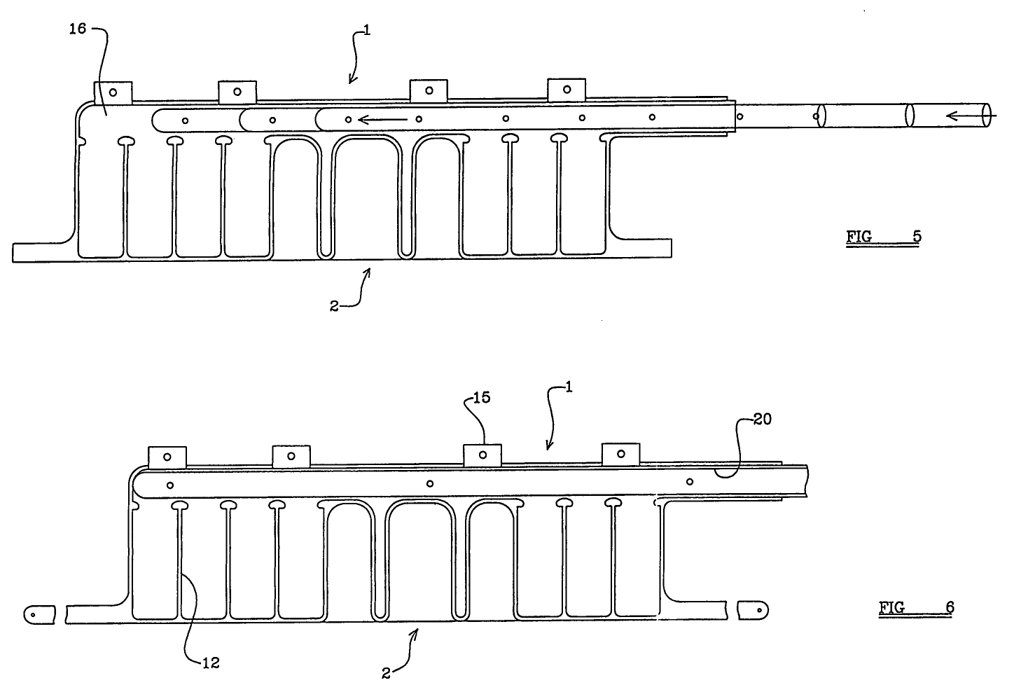

Referring initially to FIG. 1 of the accompanying drawings, an air-bag 1 in the form of a so-called “inflatable curtain” comprises a generally rectangular region 2 formed from two super-imposed sheets of fabric which are stitched together or, more preferably, formed using a one-piece weaving technique, so that there are areas where there are two layers of fabric, and other areas where the yarns which form the two layers of fabric are woven together to form only one layer of fabric. The rectangular region 2 is divided into a plurality of cells or chambers 3, 4, 5, 6, 7, 8, 9, 10, and 11 by means of seams, such as a seam 12, which extends upwardly from the lower edge 13, and which terminate the distance spaced from the upper edge 14 of the rectangular area 2. The upper edge 14 is provided with a plurality of mounting tabs 15 by means of which the air-bag 1 may be mounted in position within the roof of the vehicle. Adjacent the upper edge 14, a gas-flow passage 16 is provided extending across the whole width of the inflatable element and extending into a projection 17 adapted to be connected to a gas generator or inflator. The gas-flow passage 17 communicates with each of the cells or chambers 3 to 11. At each lower corner of the rectangular area 2, a fixing strap 18, 19 is provided.

The air-bag 1 as thus far described is conventional and, indeed, many air-bags of this general type have been proposed before with slightly differing designs.

FIG. 2 illustrates a gas-flow duct 20 which is to be inserted into the gas-flow passage 16. The gas-flow duct 20, as illustrated, is formed of fabric, and is mounted on a tubular metallic mandrel.

In the first step of the method for assembling the air-bag, a hot-melt curable adhesive 21 is applied to one or more locations on the exterior surface of the gas-flow duct. The adhesive may be applied as separate “spots” of liquid adhesive at any selected location. In FIG. 3, three spots of adhesive are shown applied to the front face of the gas-flow duct, that is to say the face of the gas-flow duct facing the viewer in the orientation shown in FIG. 3. Further adhesive may be applied to the rear face, or to the top face or even to the lower face. The positions selected for the adhesive will depend upon the detailed design of the inflatable curtain.

The preferred adhesive is a reactive polyurethane hot-melt adhesive. Such an adhesive is, initially, a hot-melt adhesive, meaning that the adhesive, when heated, may flow and therefore be applied to an item such as a gas-flow duct, but which on cooling becomes a solid with little or no “tack” property. During an initial period of time, if further heat is applied, the adhesive will re-melt. However, the adhesive is such that over a period of time it reacts with atmospheric moisture to “cure”, and then becomes a cross-linked polyurethane which will no longer melt.

The preferred adhesive is LOCTITE HYSOL 3630 as sold by Loctite Corporation of Rocky Hill, Conn., U.S.A. (LOCTITE and HYSOL are Registered Trade Marks).

The adhesive 21 may conveniently be applied to the gas-flow duct using a cartridge dispensing system in which the adhesive is molten at a set temperature suitable for pneumatic dispensing. Thus heated hot-melt adhesive, in liquid form, is applied as separate “spots” of adhesive.

The gas-flow duct 20, with the adhesive 21 thereon, is allowed to cool for a period of time. The period of time should be selected to be relatively short, for example two to three minutes, so that no substantial cross-linking of the adhesive occurs as a consequence of the contact of the adhesive with atmospheric moisture. However, the period of time must be long enough for the adhesive to set sufficiently for it to exhibit little or no tack.

In a modified embodiment of the invention the hot-melt adhesive may be provided in the form of a film or tape. One side of the tape may be provided with a pressure adhesive or glue such that the tape may easily be applied to the exterior of the gas-flow duct. Alternatively, an adhesive or glue dispenser may be used to apply the tape or film to the gas-flow duct.

Subsequently, the gas-flow duct 20 on its internal mandrel is inserted into the gas-flow passage 16 of the rectangular region 2 of the air-bag 1. Because the adhesive is solid and has no “tack” properties, this insertion step can be conducted in a straightforward manner. The temperature of the adhesive is then raised. This may be achieved in many different ways. For example, heated plates may clamp against the regions of the assembled air-bag where the adhesive is present, pressing the fabric of the air-bag 1 against the fabric of the gas-flow duct 20 in localised regions. This may be affected with the mandrel still in position. Alternatively, hot air may be directed, by means of hot air jets, to the regions of the air-bag 1 where the adhesive is located. Alternatively again, the mandrel on which the gas-flow duct 20 is mounted may be heated, by causing heated air or steam to flow through the mandrel. Alternatively, an electromagnetic field, such as High Frequency or Radio Frequency radiation may be used to raise the temperature of the adhesive 21. Again, high energy light may be used to apply heat to heat the adhesive.

In any event, the adhesive is re-heated to a temperature at which it re-melts and then serves to adhere the gas-flow duct 20 to the air-bag 1. Pressure may be applied forcing the fabric of the air-bag against the gas flow duct 20 to ensure a good adhesive bond.

The mandrel may be removed.

The assembled air-bag then has the inner gas-flow duct 20 in position and retained in position by the adhesive.

It may be appropriate to subsequently maintain the air-bag 1 within a humid atmosphere for a predetermined period of time in order to ensure that the adhesive has cured sufficiently to exhibit the desired degree of strength.

The adhesive will then no longer be capable of re-melting.

Whilst the invention has been described with reference to a method of assembling an air-bag which incorporates a fabric gas-flow duct, it is to be appreciated that the same method could be used without the need for a separate mandrel to insert a metallic or plastic gas-flow duct into an air-bag.

In a modified embodiment of the invention an adhesive may be used which is an adhesive which commences curing when initiated by light, such as ultra-violet light. The adhesive will be initiated when the gas-flow duct is in the gas-flow passage.

While the above description constitutes the preferred embodiment of the present invention, it will be appreciated that the invention is susceptible to modification, variation and change without departing from the proper scope and fair meaning of the accompanying claims.

1. A method of assembling an air-bag comprising the steps of taking a gas-flow duct which is to be located within a gas-flow passage defined by the air-bag, applying a hot-melt adhesive to one or more locations on the exterior of the gas-flow duct, permitting the hot-melt adhesive to cool to a state in which it is substantially solid and exhibits little or no tack, inserting the gas-flow duct into the gas-flow passage, subsequently applying heat so that the hot-melt adhesive at least partially melts to adhere the gas-flow duct to one or more parts of the air-bag defining the gas-flow passage.

2. A method according to claim 1 wherein the hot-melt adhesive is in the form of a film or tape of adhesive.

3. A method according to claim 2 wherein the film or tape is applied to the exterior of the gas-flow duct using an adhesive or glue.

4. A method according to claim 1, wherein the hot-melt adhesive is adapted to cure over a period of time to form a substantially cross-linked adhesive after the gas-flow duct is adhered to the parts of the air-bag defining the gas-flow passage.

5. A method according to claim 4 wherein the adhesive is adapted to cure in response to exposure to atmospheric moisture.

6. A method according to claim 1 wherein the hot-melt adhesive is a reactive polyurethane hot-melt adhesive.

7. A method according to claim 5, including a final step of exposing the combination of the air-bag and the gas-flow duct to a moist environment for a period of time.

8. A method according to claim 1 wherein the heat for the applying heat step is applied by means of a heated plate or element brought into contact with the air-bag.

9. A method according to claim 1 wherein the heat for the applying heat step is applied by at least one hot-air jet.

10. A method according to claim 1 wherein the heat for the applying heat step is applied by electromagnetic radiation of High Frequency or Radio Frequency, or by means of light.

11. A method according to claim 1 wherein the gas-flow duct is a fabric gas-flow duct, the gas-flow duct being inserted into the gas-flow passage whilst mounted on a mandrel.

12. A method according to claim 11 wherein the heat for the applying heat step is applied by heating the mandrel.

13. A method according to claim 1 wherein the gas-flow duct is a metallic or plastic gas-flow duct.

14. (canceled)

15. An air-bag having a part defining a gas-flow passage and a plurality of chambers in communication with the gas-flow passage, there being a gas-flow duct inserted into the passage, the gas-flow duct being adhered, at one or more locations, to the part of the air-bag defining the gas-flow passage by means of an adhesive.

16. An air-bag according to claim 15 wherein the adhesive is a light reacting adhesive.

17. An air-bag according to claim 15 wherein the adhesive is a hot-melt adhesive.

18. An air-bag according to claim 17 wherein the hot-melt adhesive is a hot-melt and curable adhesive.

19. An air-bag according to claim 18 wherein the adhesive is a reactive polyurethane hot-melt adhesive.

20. An air-bag according to claim 17 wherein the gas-flow passage communicates with a plurality of zones, regions, chambers or cells within the air-bag which are adapted to be inflated on deployment of the air-bag.

21. An air-bag according to claim 15 wherein the air-bag is an inflatable curtain.

22. An air-bag according to claim 15 wherein the adhesive is a hot-melt adhesive applied at a plurality of locations along the gas-flow duct.

23. An air-bag according to claim 15 wherein the gas-flow duct is formed of a metallic or plastic material.
